(19) United States
(12) Patent Application Publication
(10) Pub. No.: US 2026/0105557 A1
(43) Pub. Date: Apr. 16, 2026

(54) POPULATION OUTPUT DEVICE AND ESTIMATION MODEL

(71) Applicant: NTT DOCOMO, INC., Tokyo (JP)

(72) Inventors: Yusuke NAKAMURA, Chiyoda-ku (JP); Shin ISHIGURO, Chiyoda-ku (JP); Tomohiro MIMURA, Chiyoda-ku (JP)

(73) Assignee: NTT DOCOMO, INC., Tokyo (JP)

(21) Appl. No.: 19/114,861

(22) PCT Filed: Jul. 24, 2023
(86) PCT No.: PCT/JP2023/027001

§ 371 Date: Mar. 25, 2025

(30) Foreign Application Priority Data
Nov. 7, 2022 (JP) 2022-178010

(51) Int. Cl. G06Q 50/26

(52) U.S. Cl. CPC G06Q 50/26

(57) ABSTRACT

A population output device 1 includes a storage unit 11 that stores an estimation model that receives an input of area information related to an area and including information related to a population of the area and information related to a summation value, for each type of a map element, related to one or more map elements constituting map data of the area, and outputs population information related to a population estimated for each type of the map element of the area, an acquisition unit 10 that acquires the area information related to a target area that is an area to be targeted, and an output unit 13 that outputs the population information related to the target area, the population information being output by inputting the acquired area information related to the target area to the stored estimation model.

### TECHNICAL FIELD

One aspect of the present disclosure relates to a population output device and an estimation model that output information on a population of an area to be targeted.

### BACKGROUND ART

Patent Literature 1 discloses an information processing system that estimates a population of a cell (population estimation unit area) formed by a base station.

### CITATION LIST

### Patent Literature

Patent Literature 1: Japanese Unexamined Patent Publication No. 2020-155799

### SUMMARY OF INVENTION

### Technical problem

However, in the information processing system, information on a population in a range smaller than the cell cannot be estimated. Therefore, it is desired to output information on a population in a more detailed range.

### Solution to Problem

An aspect of the present disclosure provides a population output device including: a storage unit that stores an estimation model that receives an input of area information related to an area and including information related to a population of the area and information related to a summation value, for each type of a map element, related to one or more map elements constituting map data of the area, and outputs population information related to a population estimated for each type of the map element of the area; an acquisition unit that acquires the area information related to a target area that is an area to be targeted; and an output unit that outputs the population information related to the target area, the population information being output by inputting the area information related to the target area acquired by the acquisition unit to the estimation model stored in the storage unit.

Another aspect of the present disclosure provides an estimation model that is a trained model used by a population output device including an acquisition unit that acquires area information related to an area and including information related to a population of the area and information related to a summation value, for each type of a map element, related to one or more map elements constituting map data of the area, and an output unit that outputs population information related to a population estimated for each type of the map element of the area, in which the estimation model is configured by a neural network that has learned a weighting coefficient based on the area information related to the area and information related to a population for each type of the map element of the area, and the output unit outputs the population information related to a target area that is an area to be targeted, the population information being output by inputting the area information acquired by the acquisition unit and related to the target area to the estimation model.

In such aspects, the population information related to the population estimated for each type of the map element constituting the map data of the target area is output. That is, it is possible to output the information related to the population in a more detailed range.

### Advantageous Effects of Invention

According to one aspect of the present disclosure, it is possible to output the information related to the population in a more detailed range.

### BRIEF DESCRIPTION OF DRAWINGS

FIG. 1 A diagram showing an example of a system configuration of a population output system including a population output device according to an embodiment.

FIG. 2 An image diagram of input and output of the population output device according to the embodiment.

FIG. 3 An image diagram of input and output data used by the population output device according to the embodiment.

FIG. 4 A diagram showing an example of a functional configuration of the population output device according to the embodiment.

FIG. 5 A diagram showing an example of map data of an area.

FIG. 6 A diagram in which a polygon and a link are extracted from the map data of FIG. 5.

FIG. 7 A diagram in which only the polygon and the link of FIG. 6 are extracted.

FIG. 8 A diagram in which positional data is plotted on FIG. 7.

FIG. 9 A diagram showing a table example of a total number of people for each type of a map element.

FIG. 10 A diagram showing a table example of a number-of-people ratio for each type of the map element.

FIG. 11 A diagram showing a table example of the number and a total area for each type of the map element.

FIG. 12 A diagram showing a table example of the number and a total length for each type of the map element.

FIG. 13 An image diagram of input and output of an estimation model.

FIG. 14 A flowchart showing an example of learning processing executed by the population output device according to the embodiment.

FIG. 15 An image diagram in which a population for each type of the map element is computed from the number-of-people ratio for each type of the map element.

FIG. 16 An image diagram in which a population for each map element is computed from the population for each type of the map element.

FIG. 17 A flowchart showing an example of population output processing executed by the population output device according to the embodiment.

FIG. 18 A flowchart showing another example of the population output processing executed by the population output device according to the embodiment.

FIG. 19 A diagram showing an example in which a station spans a plurality of areas.

FIG. 20 A diagram showing an example of implementation by the population output device according to the embodiment.

FIG. 21 A diagram showing an example of a hardware configuration of a computer used in the population output device according to the embodiment.

### DESCRIPTION OF EMBODIMENTS

Hereinafter, an embodiment of the present disclosure will be described in detail with reference to the drawings. In the description of the drawings, the same elements are denoted by the same reference numerals, and the duplicated description will not be repeated. In addition, the embodiment in the present disclosure in the following description is a specific example of the present invention, and the present invention is not limited to the embodiment unless otherwise specified.

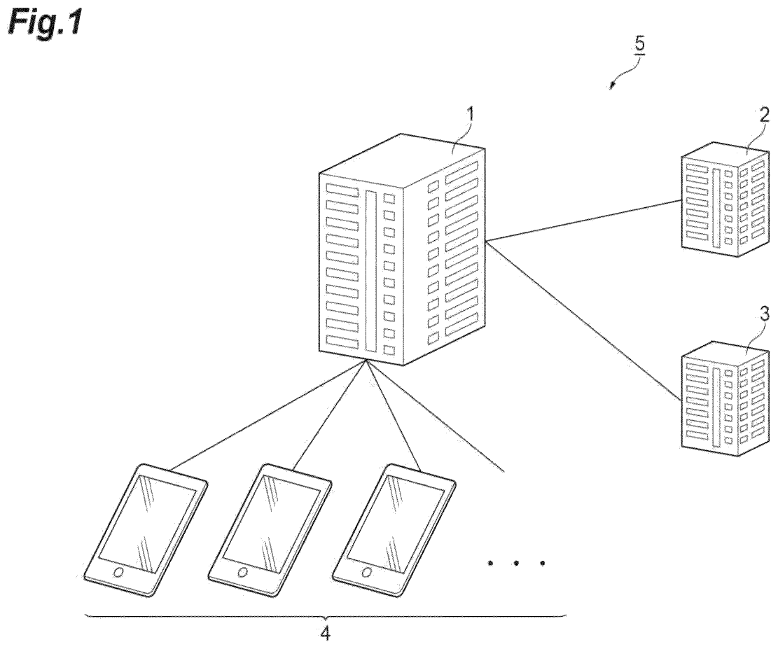

FIG. 1 is a diagram showing an example of a system configuration of a population output system 5 including a population output device 1 according to the embodiment. As shown in FIG. 1, the population output system 5 includes the population output device 1, an area population computation device 2, an external server 3, and one or more user terminals 4 (collectively referred to as a “user terminal 4” as appropriate). The population output device 1 and the area population computation device 2, and the population output device 1 and the external server 3 are communicably connected to each other through a network such as the Internet, and can transmit and receive information to and from each other. The population output device 1 and each user terminal 4 are communicably connected to each other by a network such as a mobile communication network, and can transmit and receive information to and from each other.

The population output device 1 is a computer device that outputs information related to a population of an area. The area is a predetermined area such as a mesh, a section, a compartment, a region, or a zone. Details of the population output device 1 will be described below, but an image of an example of processing will be briefly described here.

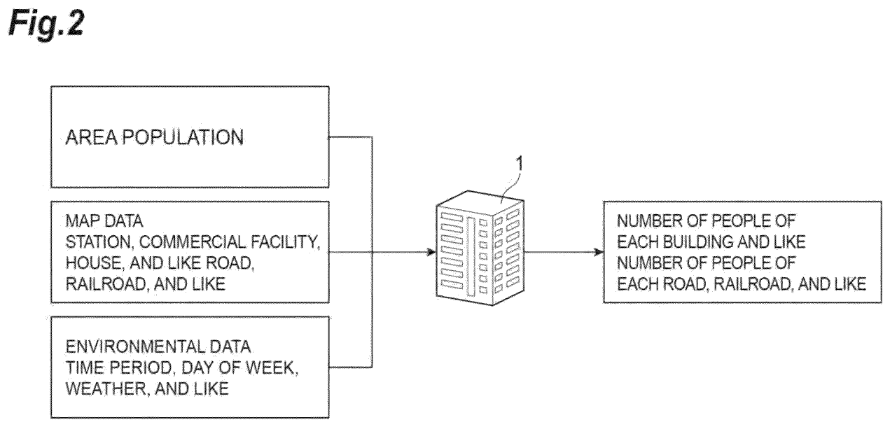

FIG. 2 is an image diagram of the input and output of the population output device 1. As shown in FIG. 2, the population output device 1 inputs an area population which is the population of the area, map data of the area, and environmental data. The map data is composed of information related to one or more map elements, such as a station, a commercial facility, and a house and such as a road and a railroad. The environmental data includes a time period, a day of the week, weather, and the like. The environmental data may be omitted as the input of the population output device 1. The population output device 1 outputs, as a response to the input, the number of people estimated (to be present in the map element) for each map element of the area. For example, the population output device 1 outputs the number of people estimated to be present in each building and the like in the area and the number of people estimated to be present in each road, railroad, and the like.

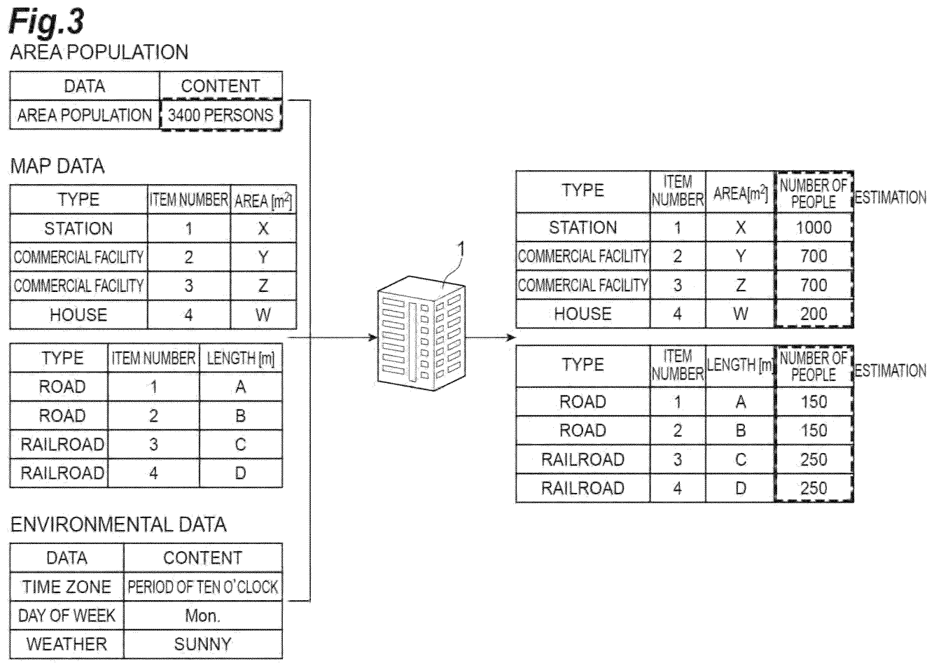

FIG. 3 is an image diagram of the input and output data used by the population output device 1. More specifically, each table example shown in FIG. 3 is a table example corresponding to each of the area population, the map data, the environmental data, and the output number of people shown in FIG. 2. As shown in FIG. 3, an area (of a polygon described below) or a length (of a link described below) of the map element is used as the map data.

The area population computation device 2 is a computer device that computes the area population of each date and time and each area and provides the area population to the population output device 1. For the computation of the area population by the area population computation device 2, for example, existing technology such as mobile spatial statistics (registered trademark) is used.

The external server 3 is a computer device that provides the map data of each area and weather data of each date and time and each area to the population output device 1. It is assumed that the map data, the weather data, and the like are stored in the external server 3 in advance. The external server 3 may be configured by a plurality of computer devices, each of which provides each data.

The user terminal 4 is a computer device, such as a mobile communication terminal, which is carried by each user of the population output device 1 and performs mobile communication. In the embodiment, a smartphone is assumed as the user terminal 4, but the present disclosure is not limited thereto. The user terminal 4 includes a global positioning system (GPS), and acquires positional data (latitude, longitude, and the like) related to a current position of the user terminal 4 by using the GPS. The positional data also includes information related to the date and time when the position is computed. The user terminal 4 may acquire the positional data based on information related to a base station or Wi-Fi (registered trademark) without using the GPS. The user terminal 4 acquires the positional data as appropriate, and transmits the acquired positional data to the population output device 1 as appropriate.

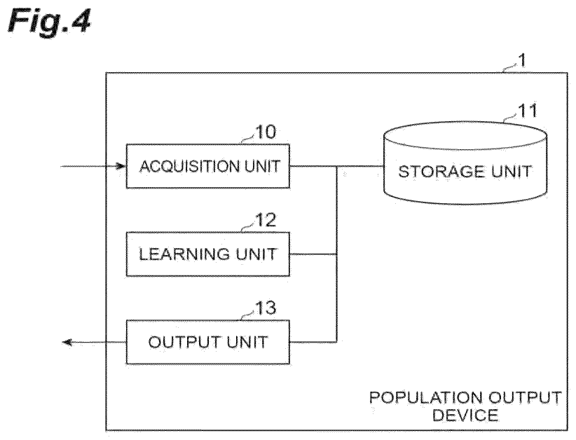

FIG. 4 is a diagram showing an example of a functional configuration of the population output device 1 according to the embodiment. As shown in FIG. 4, the population output device 1 includes an acquisition unit 10 (acquisition unit), a storage unit 11 (storage unit), a learning unit 12 (learning unit), and an output unit 13 (output unit).

Each functional block of the population output device 1 is assumed to function in the population output device 1, but the present disclosure is not limited thereto. For example, some functional blocks of the population output device 1 may function while transmitting and receiving, as appropriate, information with the population output device 1 in a computer device that is different from the population output device 1 and connected to the population output device 1 via a network. In addition, some functional blocks of the population output device 1 need not be provided, a plurality of functional blocks may be integrated into one functional block, or one functional block may be decomposed into a plurality of functional blocks.

Hereinafter, each function of the population output device 1 shown in FIG. 4 will be described.

The acquisition unit 10 acquires (receives) information used in the population output device 1 from another device and the like through a network.

The acquisition unit 10 acquires the area population of each date and time and each area from the area population computation device 2. The area population acquired by the acquisition unit 10 may be the area population of all areas in a preset period and area, or may be the area population of the area at the date and time designated by the learning unit 12 described below.

The acquisition unit 10 acquires the map data of each area, and the weather data of each date and time and each area from the external server 3. The map data acquired by the acquisition unit 10 may be all map data of a preset area or map data of the area designated by the learning unit 12 described below. The weather data acquired by the acquisition unit 10 may be all the weather data of the preset period and area, or may be the weather data of the period and area designated by the learning unit 12 described below.

The acquisition unit 10 acquires the positional data from the user terminal 4.

The acquisition unit 10 acquires area information related to a target area, which is an area to be targeted, from an administrator or a user of the population output device 1 via a communication device 1004 or an input device 1005 described below. Details of the area information will be described below.

The storage unit 11 stores the information acquired by the acquisition unit 10. More specifically, the storage unit 11 stores the area population, the map data, the weather data, and the positional data. The storage unit 11 stores an estimation model prepared in advance or an estimation model trained by the learning unit 12 described below. Details of the estimation model will be described below. The storage unit 11 may also store any information used in the computation in the population output device 1, the result of the computation in the population output device 1, and the like. The information stored in the storage unit 11 may be referred to by each function of the population output device 1 as appropriate.

The learning unit 12 trains the estimation model based on the area information related to the area and information related to the population for each type of the map element of the area.

The area information related to the area includes information related to the population of the area and information related to a summation value, for each type of the map element, related to one or more map elements constituting the map data of the area.

The information related to the population of the area may be a population that is the number of people who are present in or are assumed to be present in the area, or may be any information related to the population, rather than the population itself.

The map data is data related to the map, and is, for example, data related to a general two-dimensional map provided on the Internet.

The map elements are, for example, a facility A, a facility B, a park C, a station D, a station E, a station F, a house G, a road H, a road I, a road J, a railroad K, a railroad L, and the like.

The type of the map element may include at least one of a facility, a park, a station, a house, an office, a restaurant, an event venue, a lake, a river, a mountain, a road, or a railroad.

A summation target of the summation value related to the map element (for each type of the map element) may include at least one of the number of the map elements, an area of the polygon indicating the map element, or a length of the link indicating the map element.

The area information may further include the environmental data related to the environment. The environment may include at least one of a timing at which the population is measured or weather of the area at the timing. The timing is, for example, the time period, the day of the week, a holiday, a day of a large-scale event, and the like.

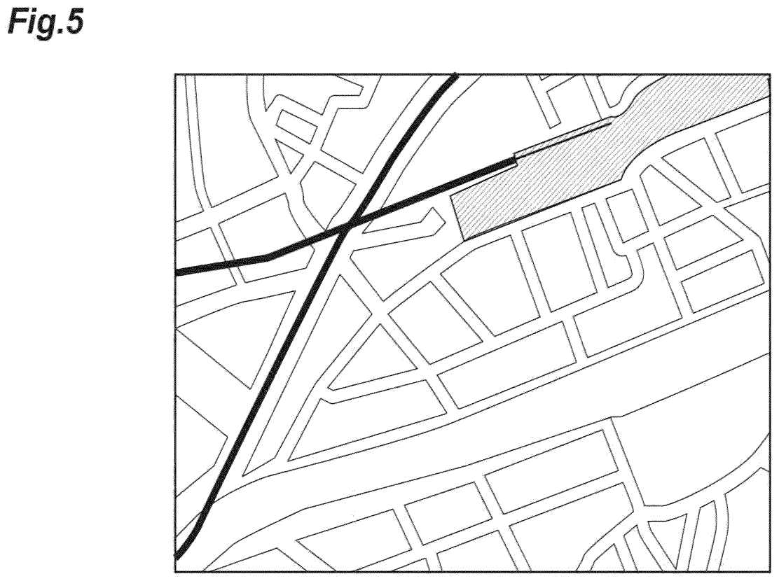

A specific example of the training of the estimation model via the learning unit 12 will be described in detail with reference to FIGS. 5 to 14.

The learning unit 12 generates ground truth data of the estimation model. First, the learning unit 12 acquires the map data (for example, vector format) of a certain area as the polygon (building or the like) and the (node) link (road, railroad, or the like).

FIG. 5 is a diagram showing an example of the map data of the area. The map data (for example, raster format) shown in FIG. 5 indicates an area around Shibuya Station. The map data shown in FIG. 5 includes Shibuya Station, two railroads, and a plurality of roads. In the map data shown in FIG. 5, although the display on the drawing is omitted, text (such as “Shibuya Station” and “Shibuya Mark City”) of the name of each map element, such as a building and a facility, and a symbol or an icon indicating the type of each map element may be additionally included.

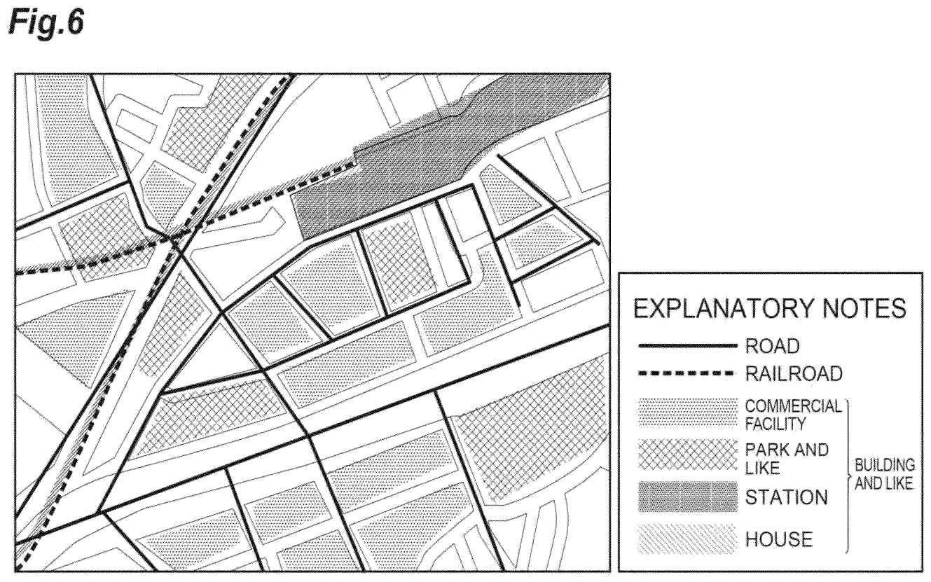

FIG. 6 is a diagram in which the polygon and the link are extracted from the map data of FIG. 5. The extraction is performed by the learning unit 12. The polygon is a polygon indicating an area range of a certain (on-map) area of a building, a facility, or the like among the map elements. The polygon may indicate, for example, a facility, a park, a station, a house, an office, a restaurant, an event venue, a lake, a river, a mountain, and the like. The link is a line connecting (on-map) nodes (for example, a station, an intersection, and the like) among the map elements. The link may indicate, for example, a road, a railroad, and the like. In a case of the extraction, the learning unit 12 may extract the polygon and the link with reference to the text, the icon, and the like included in the map data described above. In FIG. 6, the polygons (for example, vector format) corresponding to the buildings and the like extracted from the map data of FIG. 5 and the links (for example, vector format) corresponding to the roads and the railroads are displayed in a superimposed manner on the background of FIG. 5 (for example, raster format).

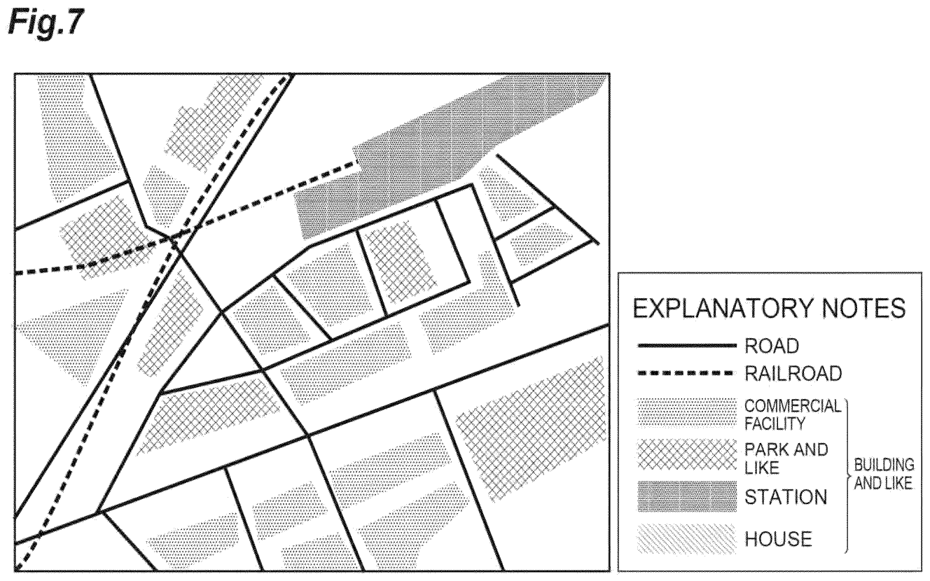

FIG. 7 is a diagram in which only the polygon and the link of FIG. 6 are extracted. The learning unit 12 uses the extracted data (for example, vector format) as shown in FIG. 7 in the subsequent processing.

Subsequently, the learning unit 12 acquires the positional data stored by the storage unit 11 and aggregates the positional data for each day of the week, time period, and weather. By aggregating the data, an influence of each error can be relatively reduced. As the aggregation, for example, data for N (N is an integer of 1 or more) days is added.

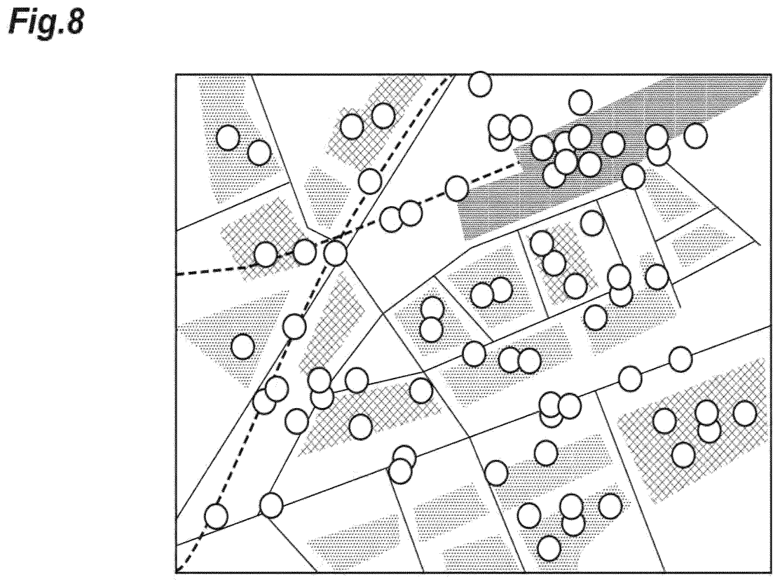

Subsequently, the learning unit 12 allocates the aggregated positional data to the extracted polygon and link. FIG. 8 is a diagram in which the positional data is plotted on FIG. 7. In FIG. 8, the positional data is represented by a circle.

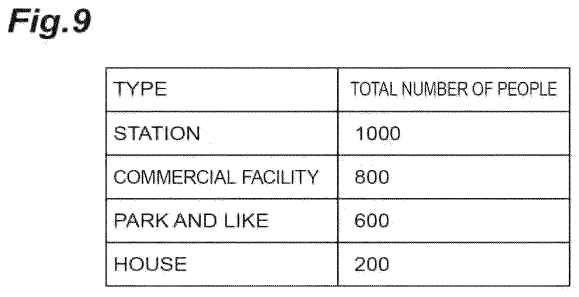

Subsequently, the learning unit 12 sums up the population included in the polygon for each type (of the map element), and sums up the population included in the link for each type (of the map element). FIG. 9 is a diagram showing a table example of a total number of people for each type of the map element. In the table example shown in FIG. 9, the type and the total number of people are associated with each other.

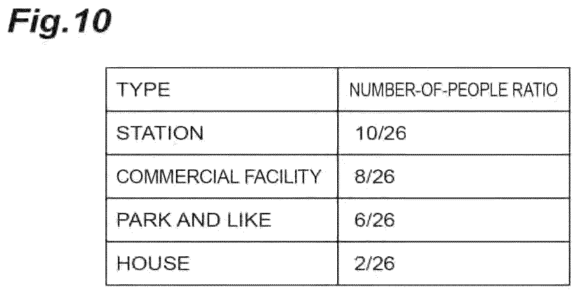

Subsequently, the learning unit 12 computes a number-of-people ratio for each type in the entire population. FIG. 10 is a diagram showing a table example of the number-of-people ratio for each type of the map element. In the table example shown in FIG. 10, the type and the number-of-people ratio (a value obtained by dividing each total number of people shown in FIG. 9 by the total population “2600”) are associated with each other.

The learning unit 12 uses the information (FIG. 9) related to the total number of people or the information (FIG. 10) related to the number-of-people ratio as the ground truth data.

Then, the learning unit 12 generates the area information that is the input data of the estimation model. First, the learning unit 12 also aggregates the area population of a certain area for each day of the week, time period, and weather (for example, for N days) and computes the average value.

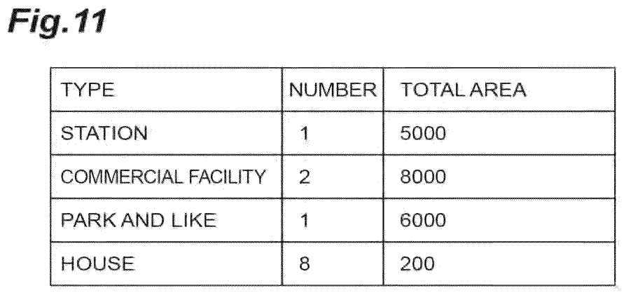

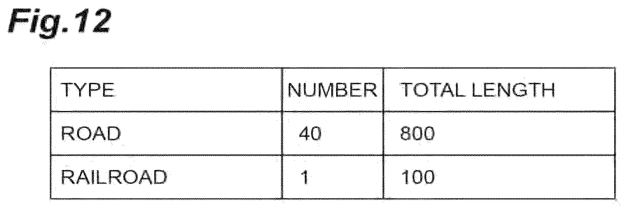

Subsequently, the learning unit 12 computes (acquires) the type, the number, and the area/length of the polygon and the links included in the map data (extracted from the map data). FIG. 11 is a diagram showing a table example of the number and a total area of the map elements (polygons) for each type. In the table example shown in FIG. 11, the type of the map element, the number of the map elements of the type, and the total area of the map elements of the type are associated with each other. FIG. 12 is a diagram showing a table example of the number and a total length of the map elements (links) for each type. In the table example shown in FIG. 12, the type of the map element, the number of the map elements of the type, and the total length of the map elements of the type are associated with each other.

The learning unit 12 generates the area information including the computed area population, and the number and the area/length of the polygons and the links of the map data for each type.

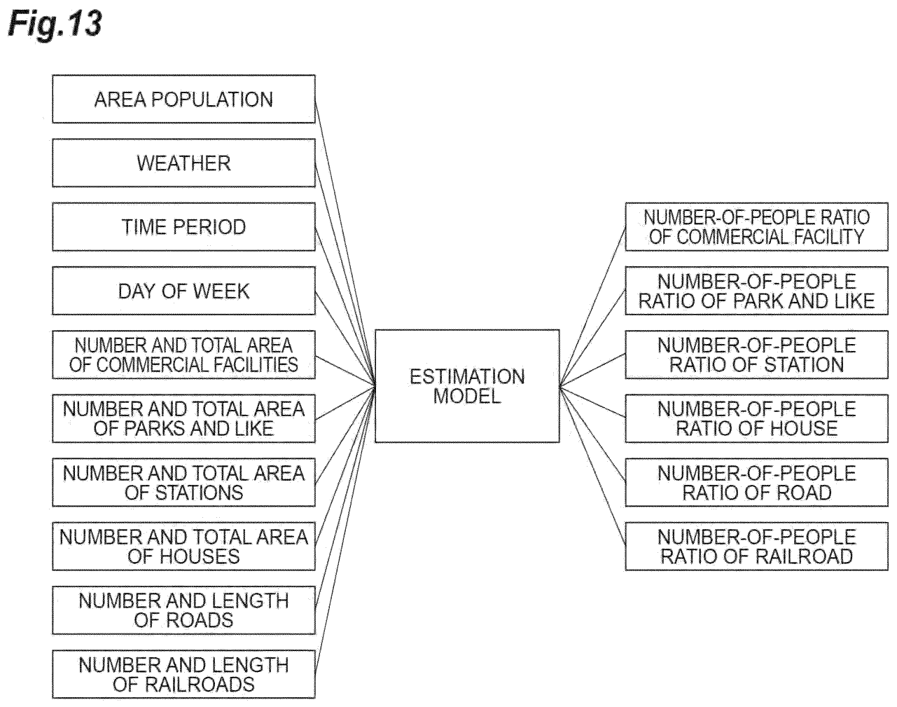

Then, the learning unit 12 performs the training of the estimation model based on the generated area information and the ground truth data. FIG. 13 is an image diagram of the input and output of the estimation model. As shown in FIG. 13, the learning unit 12 trains the estimation model so that the ground truth data is output by inputting the generated area information (which may include the environmental data).

That is, the estimation model outputs the population information, which is the information related to the population estimated for each type of the map element of the area, by inputting the area information related to the area. The population information may be a population ratio estimated for each type of the map element or may be a population (itself) estimated for each type of the map element.

The algorithm of the estimation model is not limited. An algorithm based on machine learning may be used, or an algorithm capable of estimating a continuous value such as linear regression may be used.

The estimation model may be a trained model based on a neural network. Further, the estimation model may be a trained model based on a recurrent neural network. In addition, the estimation model is not limited to the neural network, and may be a trained model based on information processing that can perform the machine learning.

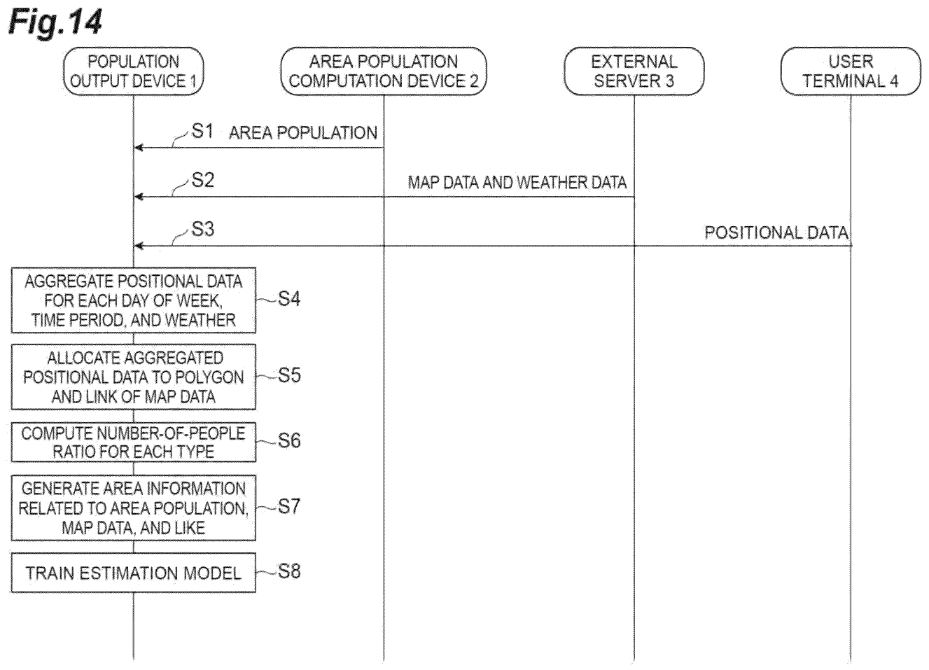

Subsequently, an example of learning processing executed by the population output device 1 will be described with reference to FIG. 14. FIG. 14 is a flowchart showing an example of the learning processing executed by the population output device 1.

First, the acquisition unit 10 acquires the area population of each date and time and each area from the area population computation device 2 (step S1). Then, the acquisition unit 10 acquires the map data and the weather data from the external server 3 (step S2). Then, the acquisition unit 10 acquires the positional data (data that is a basis of the ground truth data) from the user terminal 4 (step S3). Then, the learning unit 12 aggregates the positional data acquired in S3 for each day of the week, time period, and weather (step S4). Then, the learning unit 12 allocates the positional data aggregated in S4 to the polygon and the link of the map (step S5). Next, the learning unit 12 computes the number-of-people ratio for each type of the map element with reference to the allocation in S5 (step S6). Then, the learning unit 12 generates the area information related to the area population, the map data, and the like (step S7). Then, the learning unit 12 performs the training of the estimation model (step S8). The order of S1 to S3 may be random, and S1 to S3 may be repeated.

Returning to FIG. 4, the description of the output unit 13 will be continued.

The output unit 13 outputs the population information related to the target area, the population information being output by inputting the area information related to the target area acquired by the acquisition unit 10 to the estimation model stored in the storage unit 11. For example, in the image diagram shown in FIG. 13, the output unit 13 outputs, instead of the area information on the left side, the population information (that is the same as the population information on the right side of FIG. 13) related to the target area, the population information being output by inputting the area information related to the target area acquired by the acquisition unit 10 to the estimation model. In the area information input to the estimation model by the output unit 13, the area population is a population of a specific time period or day of the week (designated by the administrator or the user of the population output device 1) of the target area, the weather is the weather of the specific time period or day of the week, and the information related to the map element may be information in the target area. That is, the area information input to the estimation model by the output unit 13 may be information in an environment or the like desired by the administrator, the user, or the like of the population output device 1.

The output by the output unit 13 may be an output (transmission) to another device via the communication device 1004 described below, may be an output (display) via the output device 1006 described below, or may be an output (used in subsequent processing) to the output unit 13.

The output unit 13 can estimate the information related to the population of each map element in the area having no ground truth data. The output unit 13 computes the total number of people (total population) of each type by using the estimation model trained by the learning unit 12.

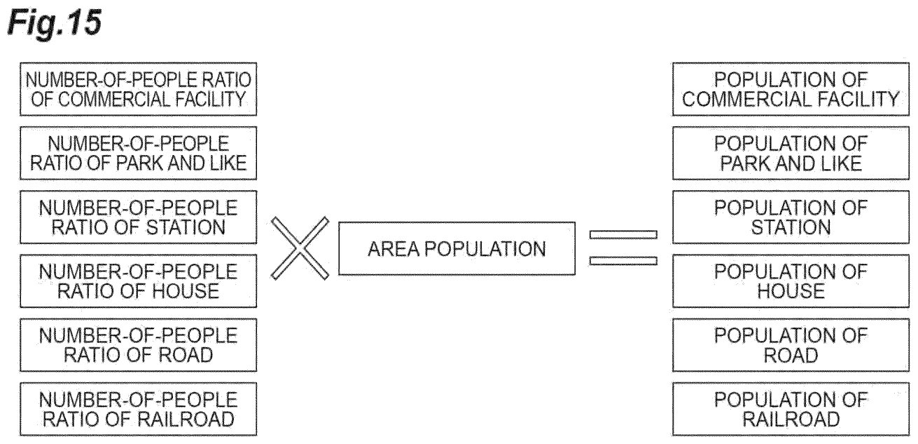

In a case in which the population information is the population ratio estimated for each type of the map element, the output unit 13 may compute the population estimated for each type of the map element of the target area based on the population information related to the target area and the population of the target area, and further output the computed population. FIG. 15 is an image diagram in which the population for each type of the map element is computed from the number-of-people ratio for each type of the map element. As shown in FIG. 15, for example, the output unit 13 computes and outputs the population of the commercial facility, the population of the park and the like, the population of the station, the population of the house, the population of the road, and the population of the railroad in the target area by multiplying the population of the target area by each of the number-of-people ratio of the commercial facility, the number-of-people ratio of the park and the like, the number-of-people ratio of the station, the number-of-people ratio of the house, the number-of-people ratio of the road, and the number-of-people ratio of the railroad in the target area.

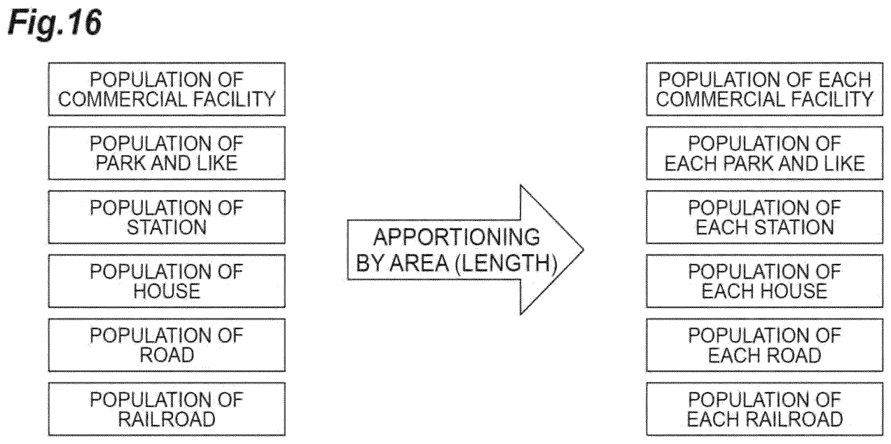

The output unit 13 may compute a population estimated for each map element based on the population estimated for each type of the map element of the target area and the information related to the map element, and further output the computed population. FIG. 16 is an image diagram in which the population for each map element is computed from the population for each type of the map element. As shown in FIG. 16, for example, the output unit 13 computes (derives) the population of each commercial facility, the population of each park and the like, the population of each station, the population of each house, the population of each road, and the population of each railroad in the target area by apportioning the population of the commercial facility, the population of the park and the like, the population of the station, the population of the house, the population of the road, and the population of the railroad in the target area by the area of each commercial facility, each area of the park and the like, each area of the station, each area of the house, each length of the road, and each length of the railroad in the target area, and outputs the computed (derived) population.

In a case in which the population information is the population estimated for each type of the map element, the output unit 13 may compute a population estimated for each map element based on the population information related to the target area and the information related to the map element of the target area, and further output the computed population. The computation and the output are the same as in the above description using FIG. 16.

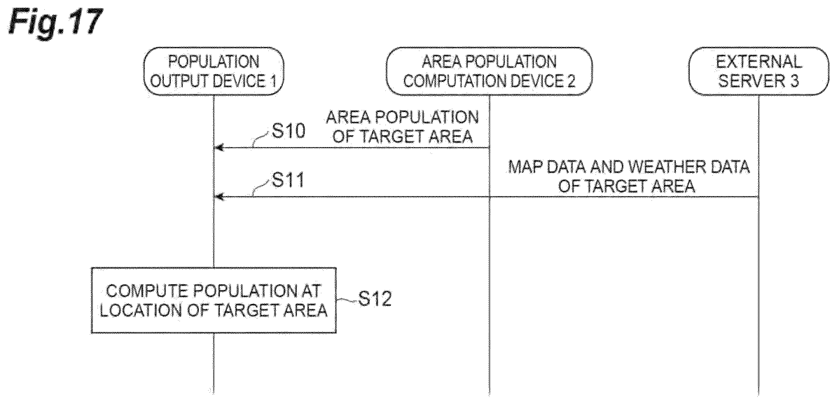

Subsequently, an example of population output processing executed by the population output device 1 will be described with reference to FIG. 17. FIG. 17 is a flowchart showing an example of the population output processing executed by the population output device 1.

First, the acquisition unit 10 acquires the area population of the target area (area including the location to be estimated) (step S10). Then, the acquisition unit 10 acquires the map data and the weather data of the target area (step S11). Then, the output unit 13 computes the population estimated for each map element (location) of the target area (step S12).

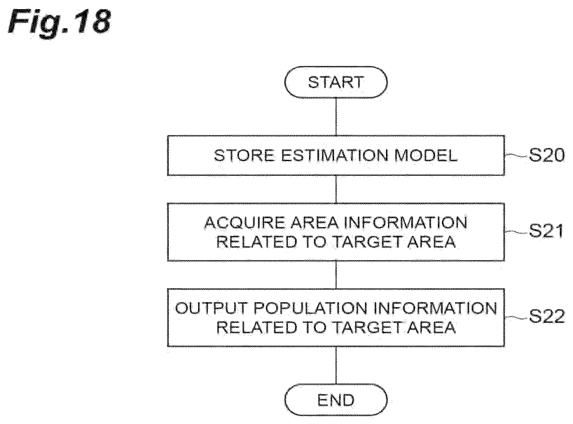

Subsequently, another example of the population output processing executed by the population output device 1 will be described with reference to FIG. 18. FIG. 18 is a flowchart showing another example of the population output processing executed by the population output device 1.

First, the storage unit 11 stores the estimation model (step S20). Then, the acquisition unit 10 acquires the area information related to the target area (step S21). Then, the output unit 13 outputs the population information related to the target area, which is output by inputting the area information related to the target area acquired in step S21 to the estimation model (step S22).

Subsequently, the operations and effects of the population output device 1 and the estimation model according to the embodiment will be described.

A population output device 1 includes a storage unit 11 that stores an estimation model that receives an input of area information related to an area and including information related to a population of the area and information related to a summation value, for each type of a map element, related to one or more map elements constituting map data of the area, and outputs population information related to a population estimated for each type of the map element of the area, an acquisition unit 10 that acquires the area information related to a target area that is an area to be targeted, and an output unit 13 that outputs the population information related to the target area, the population information being output by inputting the area information related to the target area acquired by the acquisition unit 10 to the estimation model stored in the storage unit 11. With this configuration, the population information related to the population estimated for each type of the map element constituting the map data of the target area is output. That is, it is possible to output the information related to the population in a more detailed range.

In the population output device 1, a summation target of the summation value related to the map element may include at least one of the number of the map elements, an area of a polygon indicating the map element, or a length of a link indicating the map element. With this configuration, the population information can be output by the area of the polygon indicating the map element or the length of the link indicating the map element, which can be easily obtained and derived.

In the population output device 1, the type of the map element may include at least one of a facility, a park, a station, a house, an office, a restaurant, an event venue, a lake, a river, a mountain, a road, or a railroad. With this configuration, the population information related to the population for each specific type of the map element can be output.

In the population output device 1, the area information may further include environmental data related to an environment. With this configuration, more accurate population information that is further based on the environmental data can be output.

In the population output device 1, the environment may include at least one of a timing at which the population is measured or weather of the area at the timing. With this configuration, more accurate population information that is based on the timing at which the population is measured or the weather in the area at the timing can be output.

In the population output device 1, the population information may be a population ratio estimated for each type of the map element, and the output unit 13 may compute a population estimated for each type of the map element of the target area based on the population information related to the target area and a population of the target area, and further output the computed population. With this configuration, the population estimated for each type of the map element of the target area can be output.

In the population output device 1, the output unit 13 may compute a population estimated for each map element based on the computed estimated population for each type of the map element of the target area and information related to the map element, and further output the computed population. With this configuration, the population estimated for each map element can be output.

In the population output device 1, the output unit 13 may compute a population estimated for each map element based on the population information related to the target area and information related to the map element of the target area, and further output the computed population. With this configuration, the population estimated for each map element can be output.

The population output device 1 may further comprise a learning unit 12 that trains the estimation model based on the area information related to the area and information related to a population for each type of the map element of the area, in which the storage unit 11 stores the estimation model trained by the learning unit 12. With this configuration, a more accurate estimation model, which is trained as appropriate, can be used.

An estimation model is a trained model used by a population output device 1 including an acquisition unit 10 that acquires area information related to an area and including information related to a population of the area and information related to a summation value, for each type of a map element, related to one or more map elements constituting map data of the area, and an output unit 13 that outputs population information related to a population estimated for each type of the map element of the area, in which the estimation model is configured by a neural network that has learned a weighting coefficient based on the area information related to the area and information related to a population for each type of the map element of the area, and the output unit 13 outputs the population information related to a target area that is an area to be targeted, the population information being output by inputting the area information acquired by the acquisition unit 10 and related to the target area to the estimation model. With this configuration, the population information related to the population estimated for each type of the map element constituting the map data of the target area is output. That is, it is possible to output the information related to the population in a more detailed range.

In the above description, the day of the week, the weather, the time period, and the like have been described as the aggregation unit of the data, but the aggregation may be performed excluding “holiday” or “day of large-scale event”.

In the above description, the weather, the day of the week, and the like may be omitted from the environmental data. In addition, the time period may be morning, noon, night, midnight, or the like, or may be in units of hours. The map data need only include at least two types of the polygon (facility, park, house, or the like) and the node link (railroad and road considered as a whole). The polygon and the node link may be subdivided. For example, the node link may be subdivided into a road and a railroad, or may be subdivided into a highway and a general road.

In the above description, the term “area” may be replaced with a mesh, a section, a compartment, a region, a zone, or the like. In addition, the term “map element” may be replaced with a location or the like. In addition, the term “number of people” may be replaced with “population”, and the term “population” may be replaced with “number of people”.

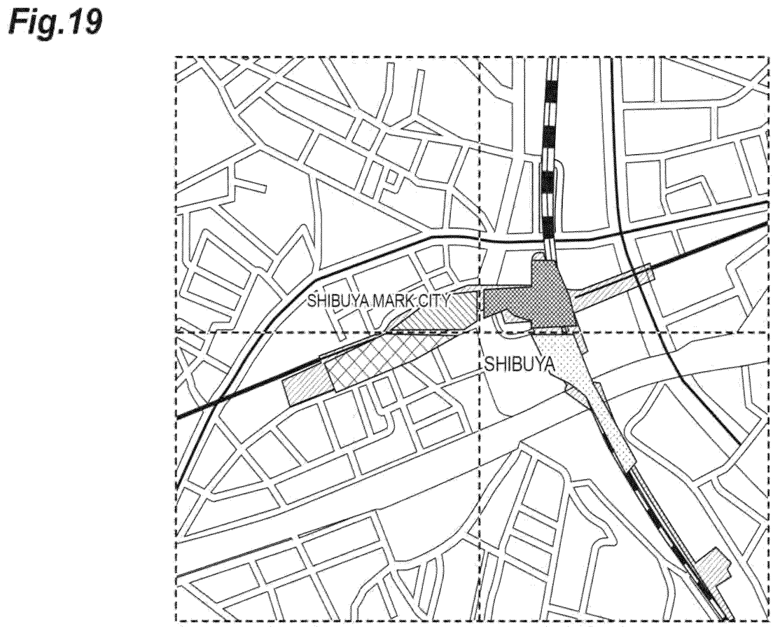

FIG. 19 is a diagram showing an example in which the station spans a plurality of areas. For example, in a case in which Shibuya Station extends over four areas as shown in FIG. 19, the population output device 1 may compute the population of a part of Shibuya Station included in each area by using each of the above-described methods, sum up the populations of the part of Shibuya Station in each area to derive the population of Shibuya Station, and provide or distribute the computed population of Shibuya Station to the outside. In a case in which the computed population is small, the deletion of the decimal point may be performed from the viewpoint of privacy protection.

The population output device 1 may be a device that computes the population at each facility, road, and the like (hereinafter, each location) from data of the population included in the area, the device being a system that learns the number-of-people ratio of each location based on static geographic information and environmental data, predicts the number-of-people ratio of each location even in a case in which detailed positional data cannot be acquired, and multiplies the number-of-people ratio of each location by the area population, to compute the number of people at each location. The population output device 1 may estimate the population of each location from the map, the environment, and the area population.

The estimation model may be a trained model used by a population output device 1 including an acquisition unit 10 that acquires area information related to an area and including information related to a population of the area and information related to a summation value, for each type of a map element, related to one or more map elements constituting map data of the area, and an output unit 13 that outputs population information related to a population estimated for each type of the map element of the area, in which the estimation model is configured by a neural network that has learned a weighting coefficient based on the area information related to the area and information related to a population for each type of the map element of the area, and the output unit 13 outputs the population information related to a target area that is an area to be targeted, the population information being output by inputting the area information acquired by the acquisition unit 10 and related to the target area to the estimation model.

The population output device 1 may be a mesh population granulation system.

As the background, there is data called a mesh population, which is “how many people are present in a specific regional mesh”. This data is useful for grasping the demographics of each area, but, in a case of analyzing the population related to the station and the facility, it may be desired to acquire more detailed information of the congestion (each population of the station and each facility, road, and the like) than the mesh population.

In the related art, dynamic values such as the population of people who stay in a commercial facility and a station cannot be estimated. For example, a method of counting the population of people who stay in each building from a GPS signal or an access log to Wi-Fi (registered trademark) is also conceivable. However, there are problems in that the GPS signal includes an error and the tendency of data may be biased because a sample size is limited.

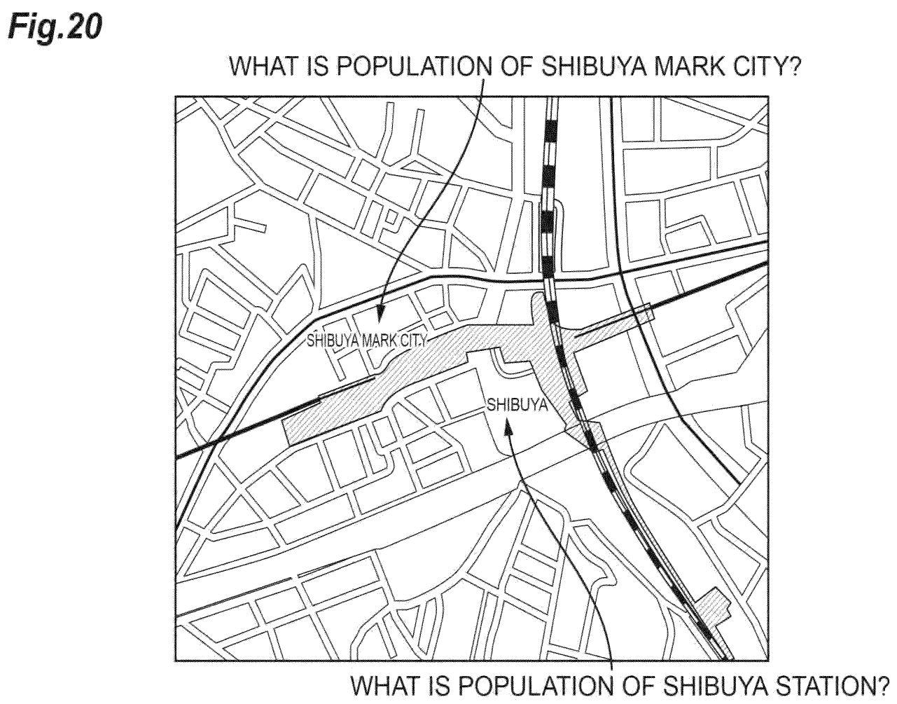

With the population output device 1, it is possible to acquire a more detailed location of congestion (each population of the station and each facility, the road, and the like) than the mesh population. FIG. 20 is a diagram showing an example of implementation by the population output device 1. As shown in FIG. 20, with the population output device 1, it is possible to acquire the population of Shibuya Mark City and acquire the population of Shibuya Station.

The population output device 1 according to the present disclosure may have the following configuration.
[1]
A population output device including: a storage unit that stores an estimation model that receives an input of area information related to an area and including information related to a population of the area and information related to a summation value, for each type of a map element, related to one or more map elements constituting map data of the area, and outputs population information related to a population estimated for each type of the map element of the area; an acquisition unit that acquires the area information related to a target area that is an area to be targeted; and an output unit that outputs the population information related to the target area, the population information being output by inputting the area information related to the target area acquired by the acquisition unit to the estimation model stored in the storage unit.
[2]
The population output device according to [1], in which a summation target of the summation value related to the map element includes at least one of the number of the map elements, an area of a polygon indicating the map element, or a length of a link indicating the map element.
[3]
The population output device according to [1] or [2], in which the type of the map element includes at least one of a facility, a park, a station, a house, an office, a restaurant, an event venue, a lake, a river, a mountain, a road, or a railroad.
[4]
The population output device according to any one of [1] to [3], in which the area information further includes environmental data related to an environment.
[5]
The population output device according to [4], in which the environment includes at least one of a timing at which the population is measured or weather of the area at the timing.
[6]
The population output device according to any one of [1] to [5], in which the population information is a population ratio estimated for each type of the map element, and the output unit computes a population estimated for each type of the map element of the target area based on the population information related to the target area and a population of the target area, and further outputs the computed population.
[7]
The population output device according to [6], in which the output unit computes a population estimated for each map element based on the computed estimated population for each type of the map element of the target area and information related to the map element, and further outputs the computed population.
[8]
The population output device according to any one of [1] to [5], in which the output unit computes a population estimated for each map element based on the population information related to the target area and information related to the map element of the target area, and further outputs the computed population.
[9]
The population output device according to any one of [1] to [8], further including: a learning unit that trains the estimation model based on the area information related to the area and information related to a population for each type of the map element of the area, in which the storage unit stores the estimation model trained by the learning unit.

The block diagram used in the description of the above-described embodiment shows blocks in functional units. These functional blocks (components) are implemented by any combination of at least one of hardware or software. In addition, a method of implementing each functional block is not particularly limited. That is, each functional block may be implemented by using one device that is physically or logically coupled, or may be implemented by connecting two or more devices that are physically or logically separated directly or indirectly (for example, using wired or wireless connections), and using these plurality of devices. The functional block may be implemented by combining software with the one device or the plurality of devices described above.

The functions include, but are not limited to, determining, determining, judging, calculating, computing, processing, deriving, investigating, looking up, search, inquiry, ascertaining, receiving, transmitting, outputting, accessing, resolving, selecting, choosing, establishing, comparing, assuming, expecting, regarding, broadcasting, notifying, communicating, forwarding, configuring, reconfiguring, allocating, mapping, and assigning. For example, the functional block (component) that functions to perform transmission is referred to as a transmitting unit or a transmitter. In any case, as described above, the method of implementing the above-described method is not particularly limited.

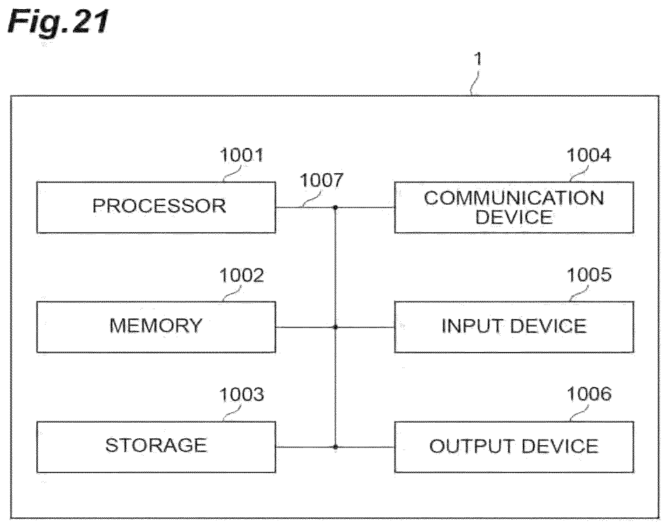

For example, the population output device 1 according to the embodiment of the present disclosure may function as a computer that performs processing of a learning method and a population output method of the present disclosure. FIG. 21 is a diagram showing an example of a hardware configuration of the population output device 1 according to the embodiment of the present disclosure. The population output device 1 may be physically configured as a computer device including a processor 1001, a memory 1002, a storage 1003, a communication device 1004, an input device 1005, an output device 1006, a bus 1007, and the like.

In the following description, the term “device” can be interpreted as a circuit, a device, a unit, or the like. The hardware configuration of the population output device 1 may include one or a plurality of devices shown in the drawings, or may not include some of the devices.

In a case in which a predetermined software (program) is loaded on hardware such as the processor 1001 and the memory 1002, the processor 1001 performs arithmetic operations to control the communication via the communication device 1004 or control at least one of reading or writing of data in the memory 1002 and the storage 1003, thereby implementing each of the functions of the population output device 1.

The processor 1001 controls the entire computer by, for example, operating an operating system. The processor 1001 may be configured by a central processing unit (CPU) including an interface with a peripheral device, a control device, an arithmetic device, a register, and the like. For example, the acquisition unit 10, the learning unit 12, the output unit 13, and the like may be implemented by the processor 1001.

The processor 1001 reads out a program (program code), a software module, data, and the like from at least one of the storage 1003 or the communication device 1004 to the memory 1002, and executes various types of processing in accordance with the program, the software module, the data, and the like. As the program, a program that causes the computer to execute at least a part of the operations described in the above-described embodiment is used. For example, the acquisition unit 10, the learning unit 12, and the output unit 13 may be stored in the memory 1002 and implemented by a control program operating in the processor 1001, and other functional blocks may be implemented in the same manner. Various types of processing described above are described as being executed by one processor 1001, but may be simultaneously or sequentially executed by two or more processors 1001. The processor 1001 may be implemented by one or more chips. The program may be transmitted from a network via an electric telecommunication line.

The memory 1002 is a computer-readable recording medium, and may be configured by, for example, at least one of a read-only memory (ROM), an erasable programmable ROM (EPROM), an electrically erasable programmable ROM (EEPROM), or a random-access memory (RAM). The memory 1002 may be referred to as a register, a cache, a main memory (main storage device), and the like. The memory 1002 can store an executable program (program code), a software module, and the like for implementing the wireless communication method according to one embodiment of the present disclosure.

The storage 1003 is a computer-readable recording medium, and may be configured by at least one of, for example, an optical disk such as a compact disc ROM (CD-ROM), a hard disk drive, a flexible disk, a magneto-optical disk (for example, a compact disc, a digital versatile disc, or a Blu-ray (registered trademark) disc), a smart card, a flash memory (for example, a card, a stick, or a key drive), a floppy (registered trademark) disk, or a magnetic strip. The storage 1003 may be referred to as an auxiliary storage device. The storage medium described above may be, for example, a database including at least one of the memory 1002 or the storage 1003, a server, or another appropriate medium.

The communication device 1004 is hardware (transceiver) for performing communication between computers via at least one of a wired network or a wireless network, and is also referred to as, for example, a network device, a network controller, a network card, a communication module, and the like. The communication device 1004 may include a high-frequency switch, a multiplexer, a filter, a frequency synthesizer, and the like, for example, in order to implement at least one of frequency division duplex (FDD) or time division duplex (TDD). For example, the acquisition unit 10, the learning unit 12, the output unit 13, and the like may be implemented by the communication device 1004.

The input device 1005 is an input device (for example, a keyboard, a mouse, a microphone, a switch, a button, a sensor, and the like) that receives an input from the outside. The output device 1006 is an output device (for example, a display, a speaker, an LED lamp, and the like) that performs output to the outside. The input device 1005 and the output device 1006 may be configured integrally (for example, a touch panel).

Each device such as the processor 1001 or the memory 1002 is connected by the bus 1007 for communicating information. The bus 1007 may be configured by a single bus or different buses between the respective devices.

The population output device 1 may include hardware such as a microprocessor, a digital signal processor (DSP), an application-specific integrated circuit (ASIC), a programmable logic device (PLD), or a field programmable gate array (FPGA), and some or all of the functional blocks may be implemented by the hardware. For example, the processor 1001 may be implemented by using at least one of these types of hardware.

The notification of the information is not limited to the aspect/embodiment described in the present disclosure, and other methods may be used.

Each aspect/embodiment described in the present disclosure may be applied to at least one of systems using long term evolution (LTE), LTE-advanced (LTE-A), SUPER 3G, IMT-advanced, a 4th generation mobile communication system (4G), a 5th generation mobile communication system (5G), future radio access (FRA), new radio (NR), W-CDMA (registered trademark), GSM (registered trademark), CDMA2000, ultra mobile broadband (UMB), IEEE 802.11 (Wi-Fi (registered trademark)), IEEE 802.16 (WiMAX (registered trademark)), IEEE 802.20, ultra-wideband (UWB), Bluetooth (registered trademark), or other appropriate systems, and next-generation systems expanded based on these systems. Further, a plurality of systems may be combined (for example, a combination of at least one of LTE or LTE-A and 5G) and applied.

An order of the processing procedures, sequences, flowcharts, and the like of each aspect/embodiment described in the present disclosure may be interchanged as long as there is no contradiction. For example, in the method described in the present disclosure, elements of various steps are presented using an illustrative order, and the method is not limited to the presented specific order.

The input and output information and the like may be stored in a specific location (for example, a memory) or may be managed using a management table. The information and the like input and output can be overwritten, updated, or added. The output information and the like may be deleted. The input information and the like may be transmitted to another device.

The judgement may be performed by a value represented by 1 bit (0 or 1), may be performed by a Boolean value (true or false), or may be performed by comparison of numerical values (for example, comparison with a predetermined value).

Each aspect/embodiment described in the present disclosure may be used alone, in combination, or switched with each other in execution. In addition, notification of predetermined information (for example, notification of “X”) is not limited to being explicitly performed, and may be performed implicitly (for example, the notification of the predetermined information is not performed).

The present disclosure has been described in detail above, but it is clear to those skilled in the art that the present disclosure is not limited to the embodiment described in the present disclosure. The present disclosure can be implemented as a modification and change aspect without departing from the gist and scope of the present disclosure determined by the description of claims. Therefore, the description of the present disclosure is for illustrative purposes, and is not intended to limit the present disclosure in any way.

The software should be broadly construed to mean commands, command sets, codes, code segments, program codes, programs, sub-programs, software modules, applications, software applications, software packages, routines, sub-routines, objects, executable files, execution threads, procedures, functions, and the like, regardless of whether the software is referred to as software, firmware, middleware, microcode, or a hardware description language, or is called by other names.

Further, software, commands, information, and the like may be transmitted and received via a transmission medium. For example, in a case in which the software is transmitted from a website, a server, or another remote source using at least one of a wired technology (coaxial cable, optical fiber cable, twisted pair, digital subscriber line (DSL), or the like) or a wireless technology (infrared, microwave, or the like), at least one of the wired technology or the wireless technology is included in the definition of the transmission medium.

The information, the signal, or the like described in the present disclosure may be represented by using any of various different technologies. For example, the data, the instruction, the command, the information, the signal, the bit, the symbol, the chip, or the like, which may be referred to throughout the above description, may be represented using a voltage, a current, an electromagnetic wave, a magnetic field or a magnetic particle, a photo field or a photon, or a random combination thereof.

The terms described in the present disclosure and the terms required for grasping the present disclosure may be replaced with terms having the same or similar meanings.

The terms “system” and “network” used in the present disclosure are used interchangeably.

The information, the parameter, and the like described in the present disclosure may be represented by using an absolute value, may be represented by using a relative value from a predetermined value, or may be represented by using corresponding another information.

The names used for the above-described parameters are not limited in any way. Further, the mathematical expression or the like using these parameters may be different from those explicitly disclosed in the present disclosure.

The terms “determining” and “determining” used in the present disclosure may include a wide variety of operations. The “determining” and the “determining” may include, for example, regarding judging, calculating, computing, processing, deriving, investigating, looking up, search, inquiry (for example, search in a table, a database or another data structure), and ascertaining as “determining” and “determining”. In addition, the “determining” and the “determining” may include regarding receiving (for example, receiving information), transmitting (for example, transmitting information), input, output, and accessing (for example, accessing data in a memory) as “determining” and “determining”. In addition, the “determining” and the “determining” may include regarding resolving, selecting, choosing, establishing, comparing, and the like as “determining” and “determining”. That is, the “determining” and the “determining” may include regarding that any operation is “determined” or “determined”. Further, “determining (determining)” may be interpreted as “assuming,” “expecting,” “considering,”or the like.

The terms “connected” and “coupled” or various variations thereof mean various direct or indirect connections or couplings between two or more elements, and it is possible to include presence of one or more intermediate elements between two elements that are “connected” or “coupled” to each other. The coupling or the connection between the elements may be physical, logical, or a combination thereof. For example, “connecting” may be interpreted as “accessing”. In a case of being used in the present disclosure, two elements can be considered to be “connected” or “coupled” to each other with one or more electrical wires, cables, and printed electrical connections, as well as with electromagnetic energy having wavelengths in the radio frequency, microwave, and light (both visible and invisible) regions, among other non-limiting and non-inclusive examples.

In the present disclosure, the phrase “based on” does not mean “based only on” unless otherwise specified. In other words, the phrase “based on”means both “based only on”and “based at least on”.

Any reference to an element using designations such as “first,” “second,” and the like used in the present disclosure does not generally limit the quantity or order of the elements. These designations may be used in the present disclosure as a convenient method of distinguishing between two or more elements. Accordingly, the reference to first and second elements does not imply that only two elements can be adopted or that the first element should precede the second element in any manner.

The “means” in the configuration of each of the above-described devices may be replaced with “unit”, “circuit”, “device”, or the like.

In the present disclosure, in a case in which the terms “include,” “including,” and variations thereof are used, these terms are intended to be inclusive in the same manner as the term “comprising”. Further, the term “or” as used in the present disclosure is not intended to represent an exclusive logical OR.

In the present disclosure, for example, in a case in which an article is added by translation, such as “a”, “an”, and “the” in English, the present disclosure may include that a noun following these articles is in plural form.

In the present disclosure, the phrase “A and B are different” may mean that “A and B are different from each other”. The phrase may mean that “A and B are each different from C”. The terms “separated”, “coupled”, and the like may be interpreted in the same manner as “different”.

### REFERENCE SIGNS LIST

1 . . . population output device, 2 . . . area population computation device, 3 . . . external server, 4 . . . user terminal, 5 . . . population output system, 10 . . . acquisition unit, 11 . . . storage unit, 12 . . . learning unit, 13 . . . output unit, 1001 . . . processor, 1002 . . . memory, 1003 . . . storage, 1004 . . . communication device, 1005 . . . input device, 1006 . . . output device, 1007 . . . bus.

1: A population output device comprising processing circuitry configured to:
store an estimation model that receives an input of area information related to an area and including information related to a population of the area and information related to a summation value, for each type of a map element, related to one or more map elements constituting map data of the area, and outputs population information related to a population estimated for each type of the map element of the area;
acquire the area information related to a target area that is an area to be targeted; and
output the population information related to the target area, the population information being output by inputting the acquired area information related to the target area acquired by the acquisition unit to the stored estimation model

2: The population output device according to claim 1,
wherein a summation target of the summation value related to the map element includes at least one of the number of the map elements, an area of a polygon indicating the map element, or a length of a link indicating the map element.

3: The population output device according to claim 1,
wherein the type of the map element includes at least one of a facility, a park, a station, a house, an office, a restaurant, an event venue, a lake, a river, a mountain, a road, or a railroad.

4: The population output device according to claim 1,
wherein the area information further includes environmental data related to an environment.

5: The population output device according to claim 4,
wherein the environment includes at least one of a timing at which the population is measured or weather of the area at the timing.

6: The population output device according to claim 1,
wherein the population information is a population ratio estimated for each type of the map element, and
the processing circuitry is configured to compute a population estimated for each type of the map element of the target area based on the population information related to the target area and a population of the target area, and further output the computed population.

7: The population output device according to claim 6,
wherein the processing circuitry is configured to compute a population estimated for each map element based on the computed estimated population for each type of the map element of the target area and information related to the map element, and further output the computed population.

8: The population output device according to claim 1,
wherein the processing circuitry is configured to compute a population estimated for each map element based on the population information related to the target area and information related to the map element of the target area, and further output the computed population.

9: The population output device according to claim 1, comprising wherein the processing circuitry is further configured to:
train the estimation model based on the area information related to the area and information related to a population for each type of the map element of the area,
wherein the processing circuitry is configured to store the trained estimation model.

10: An non-transitory computer readable medium that stores estimation model that is a trained model used by a population output device including processing circuitry configured to acquire area information related to an area and including information related to a population of the area and information related to a summation value, for each type of a map element, related to one or more map elements constituting map data of the area, and to output population information related to a population estimated for each type of the map element of the area,
wherein the estimation model is configured by a neural network that has learned a weighting coefficient based on the area information related to the area and information related to a population for each type of the map element of the area, and
the processing circuitry configured to output the population information related to a target area that is an area to be targeted, the population information being output by inputting the acquired area information related to the target area to the estimation model.
